(19) United States
(12) Patent Application Publication
(10) Pub. No.: US 2004/0107173 A1
(43) Pub. Date: Jun. 3, 2004

(54) Operating system using artificial intelligence processing

(76) Inventor: E-Chain Cheng, Taichung (TW)

Correspondence Address: VENABLE, BAETJER, HOWARD AND CIVILETTI, LLP, P.O. BOX 34385, WASHINGTON, DC, 20043-9998, US

(21) Appl. No.: 10/722,407

(22) Filed: Nov. 28, 2003

Related U.S. Application Data
(63) Continuation-in-part of application No. 09/668,150, filed on Sep. 25, 2000, now abandoned.

(51) Int. Cl. G06G 7/00; G06E 3/00; G06E 1/00; G06F 15/18; G06F 17/00; G06N 7/04

(52) U.S. Cl. 706/54; 706/1; 706/16

(57) ABSTRACT

An operating system that uses artificial intelligence processes has an artificial intelligence engine, an experience analytic and statistical module, a modification module and a user interface. The artificial intelligence engine computes an experience analytic parameter from a front code and a rear code. The experience analytic and statistical module records and modifies the experience analytic parameter. The modification module modifies the front code and the rear code in accordance with the result of the experience analytic and statistical module calculation of the experience analytic parameter. The user interface inputs data or displays the result of the calculation. In the artificial intelligence engine, the experience analytic parameter is alternatively added to either the front code or the rear code to compute another experience analytic parameter. By such an arrangement, the operating system can automatically modify the result of the calculation in accordance with the choice or previous choices of the user.

This Patent Application is a Continuation-in-Part of patent application Ser. No. 09/668,150 filed on 25 Sep. 2000.

### BACKGROUND OF THE INVENTION

1. Field of the Invention

The present invention relates to an operating system, and more particularly to an operating system that uses artificial intelligence processing.

2. Description of Related Art

Because the data in different databases is often coded in different ways, the data elements in any given database usually cannot be directly compared or correlated with data elements generated outside the database. Therefore, an operating system to compare and correlate data elements in different databases is needed.

When a conventional operating system must operate on data elements from two different databases, the system must convert each data element every time it is used. A significant amount of time is required for each operation in the conventional operating system. The parameters and method of performing operations in the conventional operating system cannot be changed. Therefore use of the conventional operating system is limited.

To overcome the shortcomings, the present invention provides an improved operating system that uses artificial intelligence processes to mitigate or obviate the aforementioned problems.

### SUMMARY OF THE INVENTION

The main objective of the invention is to provide an improved operating system that uses artificial intelligence processes. The operating system comprises a relative comparison module, an experience analytic and statistical module, a modification module and a user interface. The relative comparison module computes an experience analytic parameter from a front code and a rear code. The experience analytic and statistical module records and modifies the experience analytic parameter. The modification module modifies the front code and the rear code in accordance with the result of the experience analytic and statistical module calculation of the experience analytic parameter. The user interface inputs data or displays the result of the calculation. In the relative comparison module, the experience analytic parameter is alternatively added to either the front code or the rear code to compute another experience analytic parameter. By such an arrangement, the operating system can automatically modify the result of the calculation in accordance with the choice or previous choices of the user. The operating system can perform automatic modifications and learn.

Another objective of the invention is to provide an improved operating system that uses an artificial intelligence process. Because the result of the correlation in the operating system is in accordance with the choice or previous choices of the user, the calculation time of the operating system will be shorter and shorter, and the result of the calculation of the system will be more and more exact.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of an operating system that uses artificial intelligence processing in accordance with the present invention;

FIG. 2 is a flow chart of the calculation of an experience analytic parameter from the front code and rear code by the artificial intelligence engine of the operating system in FIG. 1;

FIG. 3 is a block diagram of the artificial intelligence engine in FIG. 1;

FIG. 4 is a diagram of an example of the artificial intelligence deductive module of the artificial intelligence engine in FIG. 3;

FIG. 5 is a flow chart of the processes of modifying the experience analytic parameter in accordance with the choice of the user; and

FIG. 6 is a flow chart of the processes of modifying the experience parameters.

Appendix: An example of an artificial intelligence engine in accordance with the present invention.

### DETAILED DESCRIPTION OF PREFERRED EMBODIMENT

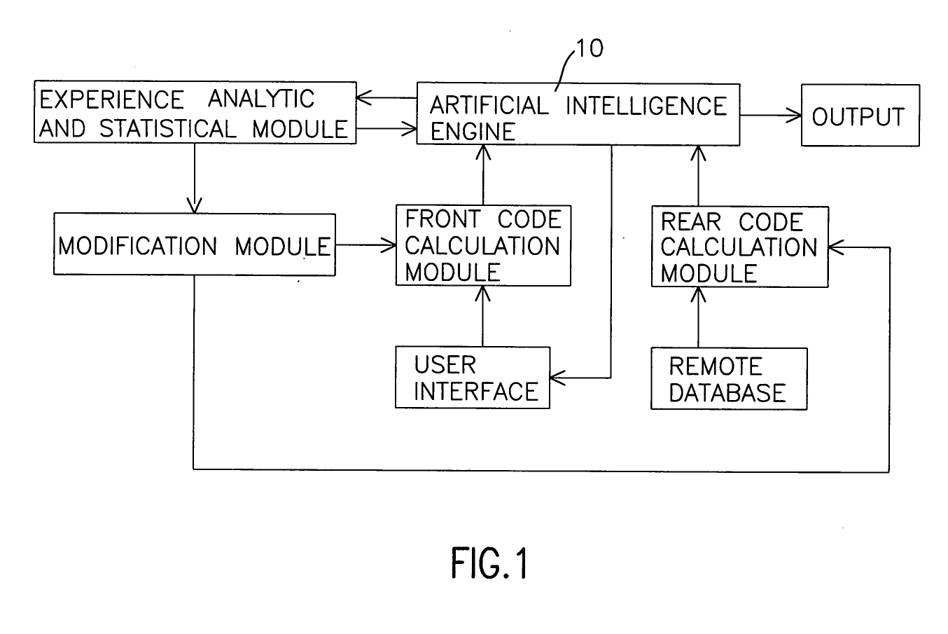

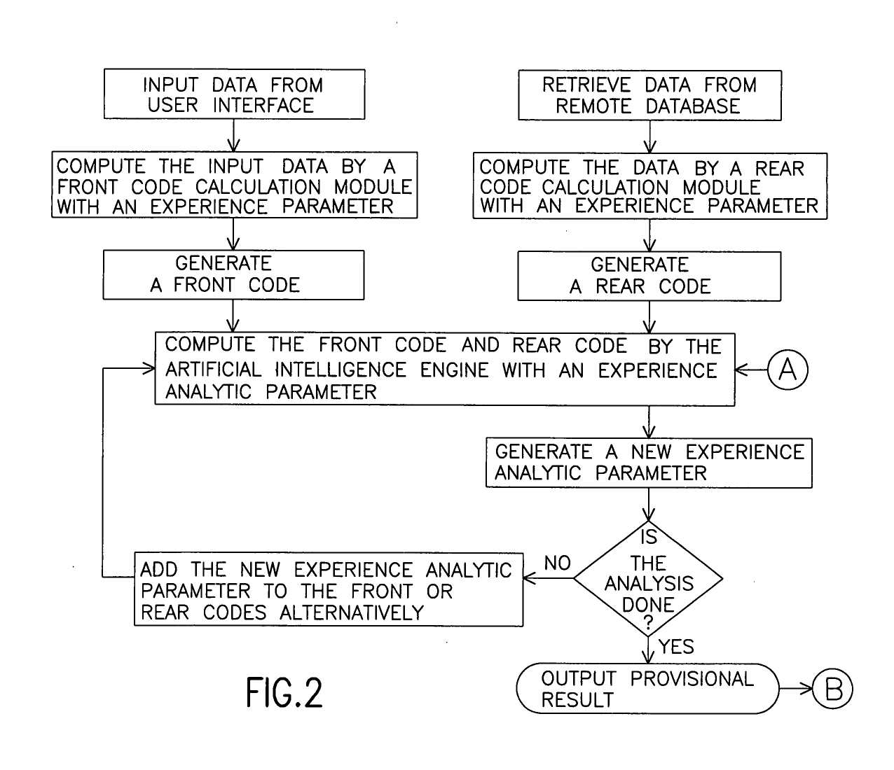

With reference to FIGS. 1 and 2, an operating system that uses artificial intelligence processing in accordance with the present invention comprises an artificial intelligence engine (10), an experience analytic and statistical module, a modification module and a user interface. The artificial intelligence engine is used to compute an experience analytic parameter from a front code and a rear code. A front code calculation module is provided to compute the front code from an input data element, and a rear code calculation module is used to compute a rear code from each data element stored in a remote database. The input data is input through the user interface. The database can interconnect with the other databases through the Internet to retrieve data from remote databases. For example, a front code 14T21F15E27M23W can be gained by the input data from the user interface, and a rear code 42T23F17E14M04W can be gained by the data element stored in a remote database.

An experience parameter is contained in each of the front code calculation module and the rear code calculation module to compute the corresponding code. The experience parameter is composed of a constant and a variable. The initial value of the variable is zero.

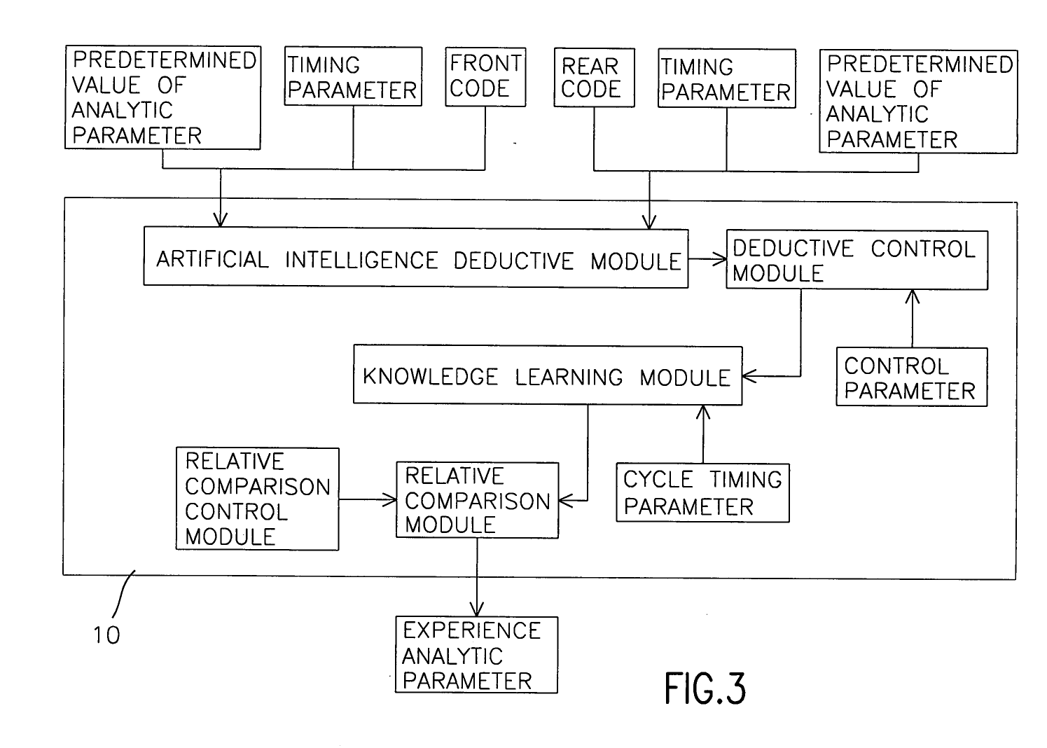

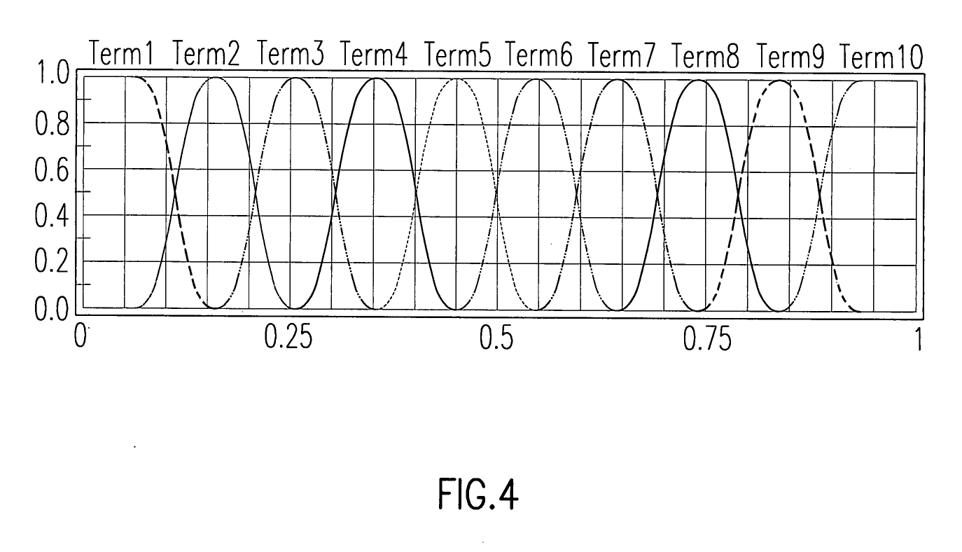

With reference to FIGS. 1 and 3, the artificial intelligence engine comprises an artificial intelligence inference module, a deductive control module, a knowledge learning module and a relative comparison module. The artificial intelligence deductive module contains a multiple artificial intelligence calculation system like the fuzzy calculation system, the nerve node calculation system, and some other non-artificial intelligence calculation systems such as the expert calculation system and so on. The artificial intelligence deductive module is used to compute an artificial intelligence value based on the corresponding front code or rear code by one of the calculation systems. The artificial intelligence deductive module can be a system identifying a fuzzy logic inference flow from input variables to output variables. FIG. 4 shows an example of the artificial intelligence deductive module, wherein the lateral coordinate axis refers to the an input value, an element of the front code or the rear code, and the longitudinal coordinate axis refers to the out value, the artificial intelligence value. In the instance of the front code 14T21F15E27M23W, the first element of the front code T is 0.14, and the output artificial intelligence value is 0.93 referring to Term 2. The fourth element of the front code M is 0.27, and the output artificial intelligence value is 0.9 referring to Term 3. Different code can bereferred to different type of artificial intelligence deductive module to gain corresponding artificial intelligence value.

The deductive control module is used to control which calculation system in the artificial intelligence deductive module operates on the control parameter. The control parameter is generated based on the items that the user inputs from the user interface. The type of the deductive control module is similar to that of the artificial intelligence deductive module and is not further described.

In addition, a cycle timing parameter can be added to each front code and rear code, such that each code will have a timing control term. The cycle timing parameter is generated based on the time each data element is input.

The knowledge learning module is used to correlate the artificial intelligence values of the corresponding front code and rear code to correlate the relationship of the corresponding intelligence values. The type of the knowledge learning module is similar to that of the artificial intelligence deductive module and is not further described. In addition, a cycle timing parameter that is generated based on the time between inputting the input data and input items of the user can be added to the knowledge learning module.

The relative comparison module is used to compute an experience analytic parameter based on the artificial intelligence values of the corresponding front code and rear code. The type of the relative comparison module is similar to that of the artificial intelligence deductive module and is not further described. At this time, a predetermined value of the experience analytic parameter can be added to the front code and rear code. The predetermined value of the experience analytic parameter can be zero if the operating system is operating the first time or a previous value that was computed the last time the operating system operated. Furthermore, a relative comparison control module is provided to set and determine the environment parameter of the relative comparison module. Appendix shows an example of an artificial intelligence engine in accordance with the present invention.

Referring to FIGS. 1 to 3, the experience analytic parameter computed by the artificial intelligence engine is then added to either the front code or the rear code to replace the predetermined value of the experience analytic parameter. For example, when the experience analytic parameter is added to the front code, the artificial intelligence engine provides another new experience analytic parameter with a new front code and the old rear code. The second experience analytic parameter is added to the other one of the front code and the rear code, in this case, to the rear code to replace the predetermined value of the experience analytic parameter. The artificial intelligence engine will provide a third experience analytic parameter with the second front code and the second rear code. By such a manner, the experience analytic parameter is alternatively added to the front code and the rear code to compute a new experience analytic parameter through the artificial intelligence engine in a number of loops which is determined by the correlating result of the knowledge learning module. In this manner, the input data can be respectively correlated with each data element in the database through the artificial intelligence engine with the corresponding front code and rear code. A provisional result that shows the relationship between the input data and each corresponding data element in the database will be generated based on the comparisons between the experience analytic parameters generated from the front code with different rear codes, and the result can be shown in the user interface.

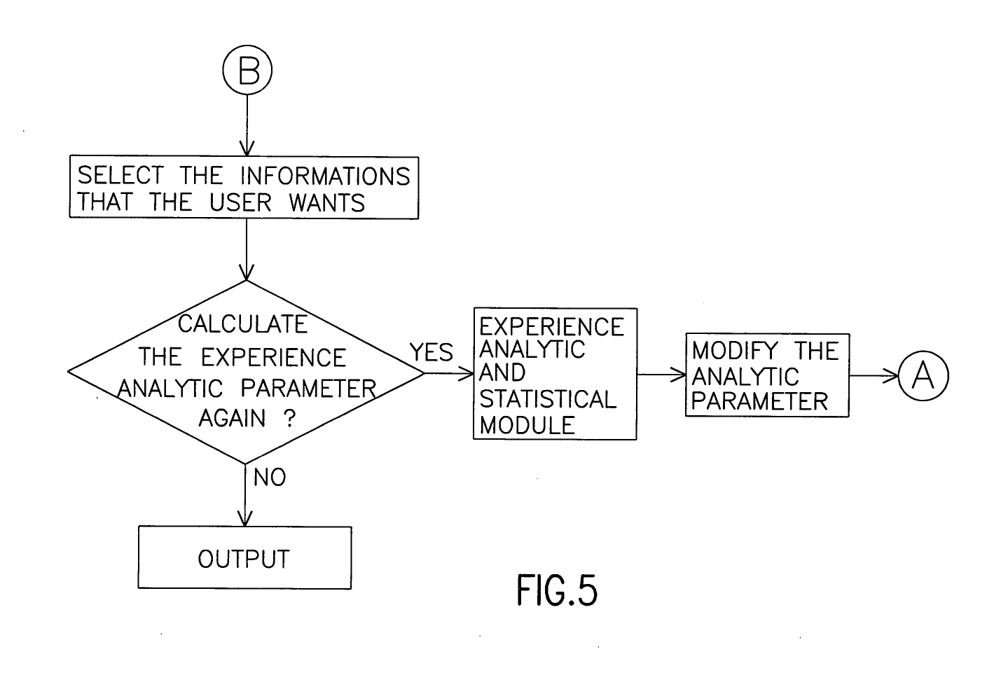

Referring to FIGS. 2, 3 and 5, when the user sees the results shown in the user interface, he or she may select the information that he or she wants through the user interface, and determine whether or not to compute again. If the information listed in the provisional result is what the user needs, the user can choose to print out the results, and the statistic and analysis module will record the experience analytic parameter corresponding to each selection of the user. If the information in the provisional result is not actually appropriate to the user, the user can choose to perform the calculation again, and the statistic and analysis module will modify the experience analytic parameter based on the selections of the user. The predetermined value will be replaced with the modified experience analytic parameter and added to the front code and rear code to compute again.

Consequently, a new provisional result will be computed with the modified experience analytic parameter in accordance with the selection of the user. Theoretically, the new provisional result will be closer to the user's needs than the old one. The operating system can modify the result of the calculation immediately based on the choice of the user. The operating system has an ability to learn.

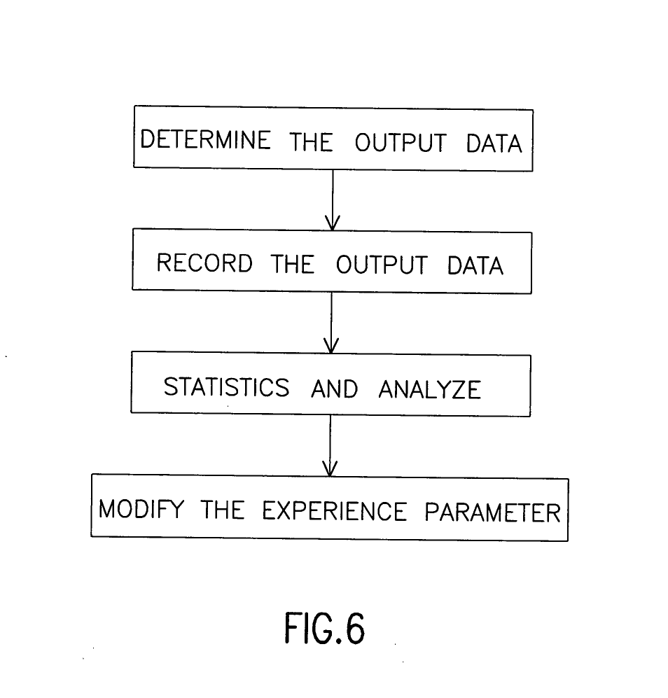

With reference to FIG. 6, when the user selects each output result through the user interface, the experience analytic and statistical module will record each experience analytic parameter corresponding to each choice of the user. The experience analytic and statistical module can compute the change of the experience analytic parameters over a desired period. The modification module can modify the experience parameters of the front code calculation module and the rear code calculation module based on the statistical result of the experience analytic and statistical module. Consequently, the front code and the rear code can be modified in accordance with the choice of the user, and the calculation result of the relative comparison module with the modified front code and the rear code will be more exact and closer to the user's needs. Therefore, the operating system has an automatic modification ability.

When the user uses the operating system next time, the predetermined values of the experience analytic parameter will be replaced with the one that was computed during the last operation of the operating system. Theoretically, the calculation result is not only more exact and closer to the user's needs, but the time to compute the result is also shorter.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An operating system that uses artificial intelligence processing comprising:
a front code and a rear code;
an artificial intelligence engine used to compute an experience analytic parameter from the front code and the rear code with a predetermined value of the experience analytic parameter, wherein the experience analytic parameter is alternatively added to either the front code or the rear code to compute a new experience analytic parameter;
an experience analytic and statistical module to record and modify the experience analytic parameter;
a modification module to modify the front code and the rear code in accordance with a calculation result of the experience analytic and statistical module about the experience analytic parameter; and
a user interface to input data or display the calculation result,
wherein the artificial intelligence engine comprises:
an artificial intelligence deductive module used to compute an artificial intelligence value based on the front code or rear code, and including a multiple artificial intelligence calculation systems;
a deductive control module with a control parameter used to control which calculation system of the artificial intelligence deductive module is used;
a knowledge learning module used to correlate the artificial intelligence values of the corresponding front code and rear code to correlate the relationship of the corresponding intelligence values; and
a relative comparison module used to compute the experience analytic parameter according to the artificial intelligence values of the corresponding front code and rear code.

2. The operating system as claimed in claim 1 further comprising a front code calculation module used to compute the front code from the data element(s) input from the user interface.

3. The operating system as claimed in claim 2, wherein the front code calculation includes an experience parameter for computing the front code.

4. The operating system as claimed in claim 3, wherein the experience parameter of the front code calculation module is composed of a constant and a variable.

5. The operating system as claimed in claim 4, wherein the variable of the experience parameter is changed by the calculation result of the modification module.

6. The operating system as claimed in claim 1 further comprising a database containing multiple data elements; and
a rear code calculation module used to compute the rear code from each data element in the database.

7. The operating system as claimed in claim 6, wherein the database is interconnected with the other database.

8. The operating system as claimed in claim 6, wherein the rear code calculation includes an experience parameter for computing the rear code.

9. The operating system as claimed in claim 6, wherein the experience parameter of the rear code calculation module is composed of a constant and a variable.

10. The operating system as claimed in claim 9, wherein the variable of the experience parameter is changed by the calculation result of the modification module.

11. The operating system as claimed in claim 1, wherein the predetermined value of the experience analytic parameter is zero.

12. The operating system as claimed in claim 1, wherein the predetermined value of the experience analytic parameter is a value which is computed by the operating system the last time.

13. The operating system as claimed in claim 1 further comprising a cycle timing parameter added to each front code and rear code.

14. The operating system as claimed in claim 13, wherein the cycle timing parameter is generated based on the time each data element is input.

15. The operating system as claimed in claim 1, wherein the calculation systems of the artificial intelligence deductive module contain a fuzzy calculation system, a nerve node calculation system and an expert calculation system.

16. The operating system as claimed in claim 1, wherein the control parameter is generated base on the items that the user inputs from the user interface.

17. The operating system as claimed in claim 1, in which a cycle timing parameter that is generated based on the time between inputting the input data and input items of the user can be added to the knowledge learning module.

18. The operating system as claimed in claim 1 further comprising a relative comparison control module used to set and determine environment parameters of the relative comparison module.
